(19) United States
(12) Patent Application Publication
(10) Pub. No.: US 2025/0390850 A1
(43) Pub. Date: Dec. 25, 2025

(54) PERMISSIONLESS CRYPTOCURRENCY ABSTRACTION WITH DECENTRALIZED LIQUIDITY

(71) Applicant: Circle Internet Group, Inc., New York, NY (US)

(72) Inventors: Calvin Cai, Boston, MA (US); Zhou Fang, Boston, MA (US); Michael Grant, Boston, MA (US); Jonathan Lim, Boston, MA (US); Kaili Wang, Boston, MA (US); Haichuan Wang, Cambridge, MA (US)

(21) Appl. No.: 18/752,710

(22) Filed: Jun. 24, 2024

(51) Int. Cl. G06Q 20/06; G06Q 20/38

(52) U.S. Cl. CPC G06Q 20/065; G06Q 20/381

(57) ABSTRACT

Implementations are directed to providing, within the chain network, a liquidity source including a set of liquidity providers that provide a pool of native cryptocurrency, receiving, by a paymaster executed in the chain network, an amount of native cryptocurrency from the pool of native cryptocurrency, receiving, by the paymaster, an amount of non-native cryptocurrency from a user to account for a transaction fee for execution of a transaction within the chain network, and after execution of the transaction: accounting for the transaction fee using at least a portion of the amount of native cryptocurrency, determining, by the paymaster, a total cost of the transaction in the non-native cryptocurrency at least partially based on a spread, and transferring, by the paymaster, respective amounts of non-native cryptocurrency to one or more liquidity providers in the set of liquidity providers based on the spread.

### TECHNICAL FIELD

This specification relates generally to digital asset transactions and more particularly to permissionless cryptocurrency abstraction with decentralized liquidity.

### BACKGROUND

The development of distributed ledger technology has enabled a multitude of digital transactions not available in the pre-Internet world. For example, distributed ledger technology enables users to hold digital assets as stores of value and mediums of exchange with immutability and traceability. In general, a digital asset can be described as a virtual store of value that leverages a distributed ledger to store, record, and validate transactions. An example digital asset includes cryptocurrencies. Distributed ledgers can be referred to as blockchains or chains.

Each chain network typically maintains a native cryptocurrency, which is used to facilitate transactions in the chain network. For example, the native cryptocurrency is used to account for transaction fees in the chain network. However, native cryptocurrencies are volatile and behave more like a speculative asset rather than a first-class currency. That is, the volatility of native cryptocurrencies makes them a non-reliable store of value. As a result, users have to constantly re-evaluate the cost of transactions with regard the value of the native cryptocurrency with respect to an underlying fiat currency (e.g., United States Dollar (USD)). This creates unnecessary overhead (in terms of time and consumption of technical resources) for each transaction.

Further, users interact with multiple chain networks, each chain network having its own native cryptocurrency. For example, a user can use a first cryptocurrency of a first chain network to account for transaction fees for a transaction in a second chain network. In traditional approaches, the first cryptocurrency is converted to a second cryptocurrency (a cryptocurrency that is native to the second chain network). This presents multiple technical issues. For example, conversion of cryptocurrencies itself consumes technical resources (processors, memory, bandwidth). Further, from a user perspective, the user has to initiate conversion transactions, which not only diminishes user experience, but also consumes technical resources on user-side computing devices.

### SUMMARY

This specification describes systems, methods, devices, and other techniques relating to cryptocurrency networks. More particularly, implementations of the present disclosure are directed to permissionless cryptocurrency abstraction with decentralized liquidity for transactions using non-native cryptocurrency. This can include, for example, onboarding of user accounts using a non-native cryptocurrency.

In general, innovative aspects of the subject matter described in this specification can include actions of providing, within the chain network, a liquidity source including a set of liquidity providers that provide a pool of native cryptocurrency, receiving, by a paymaster executed in the chain network, an amount of native cryptocurrency from the pool of native cryptocurrency, receiving, by the paymaster, an amount of non-native cryptocurrency from a user to account for a transaction fee for execution of a transaction within the chain network, and after execution of the transaction: accounting for the transaction fee using at least a portion of the amount of native cryptocurrency, determining, by the paymaster, a total cost of the transaction in the non-native cryptocurrency at least partially based on a spread, and transferring, by the paymaster, respective amounts of non-native cryptocurrency to one or more liquidity providers in the set of liquidity providers based on the spread. Other implementations of this aspect include corresponding systems, apparatus, and computer programs, configured to perform the actions of the methods, encoded on computer storage devices.

These and other implementations can each optionally include one or more of the following features: the amounts of non-native cryptocurrency transferred to the one or more liquidity providers are determined using a funds distribution standard (FDS) that is based on ratios of native cryptocurrency deposited by respective liquidity providers relative to an overall amount of native cryptocurrency in the liquidity source; actions further include storing a hash table that records a set of parameters used to calculate a returned amount of native cryptocurrency and a returned amount of non-native cryptocurrency for participation of each liquidity provider in the liquidity source; the set of parameters includes, for each log state of a plurality of log states, a set of exchange rates for the native cryptocurrency and a set of exchange rates for the non-native cryptocurrency relative to a funds distribution token (FDT); actions further include storing a linked list of liquidity providers in the chain network, the linked list of liquidity providers being used to determine the amounts of non-native cryptocurrency to one or more liquidity providers in the set of liquidity providers; actions further include using a set of pointers to define an active window of the linked list, the active window defining the one or more liquidity providers for transfer of the amounts of non-native cryptocurrency; the linked list is provided as a first-in, first-out (FIFO) queue to determine the one or more liquidity providers for transfer of the amounts of non-native cryptocurrency; a value of the spread changes over time; and the paymaster is provided and deployed to the chain network by an enterprise that provides the non-native cryptocurrency.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual architecture in accordance with implementations of the present disclosure.

FIG. 2 depicts a high-level conceptual architecture to illustrate implementations of the present disclosure.

FIG. 3 is an example signal flow diagram in accordance with implementations of the present disclosure.

FIG. 4 is an example signal flow diagram in accordance with implementations of the present disclosure.

FIG. 5 depicts a flowchart of an example process that can be executed in accordance with implementations of the present disclosure.

Like reference numbers and designations in the various drawings indicate like elements.

### DETAILED DESCRIPTION

This specification describes systems, methods, devices, and other techniques relating to cryptocurrency networks. More particularly, implementations of the present disclosure are directed to permissionless cryptocurrency abstraction with decentralized liquidity for transactions using non-native cryptocurrency. This can include, for example, onboarding of user accounts using a non-native cryptocurrency.

In some implementations, actions include providing, within the chain network, a liquidity source including a set of liquidity providers that provide a pool of native cryptocurrency, receiving, by a paymaster executed in the chain network, an amount of native cryptocurrency from the pool of native cryptocurrency, receiving, by the paymaster, an amount of non-native cryptocurrency from a user to account for a transaction fee for execution of a transaction within the chain network, and after execution of the transaction: accounting for the transaction fee using at least a portion of the amount of native cryptocurrency, determining, by the paymaster, a total cost of the transaction in the non-native cryptocurrency at least partially based on a spread, and transferring, by the paymaster, respective amounts of non-native cryptocurrency to one or more liquidity providers in the set of liquidity providers based on the spread.

To provide context for the subject matter of the present disclosure, and as introduced above, users can hold digital assets as stores of value and mediums of exchange. In general, a digital asset can be described as a virtual store of value that leverages a distributed ledger (e.g., blockchain) to store, record and validate transactions. A distributed ledger can be described as a decentralized database that immutably stores transactions across a peer-to-peer network. Distributed ledgers can be referred to as blockchains, or chains that are maintained in a chain network (e.g., a network of peer-to-peer nodes). Example digital assets can include, without limitation, cryptocurrencies (e.g., stablecoins), non-fungible tokens (NFTs), security tokens, and the like. For purposes of non-limiting illustration, implementations of the present disclosure are described in further detail herein with reference to example cryptocurrencies. It is contemplated, however, that implementations of the present disclosure can be realized using any appropriate digital assets.

In some examples, a cryptocurrency can be described as a digital currency that uses cryptography to secure transactions that are recorded in a distributed ledger (e.g., blockchain). In some examples, a stablecoin can be described as a cryptocurrency having a value that is tied (pegged) to the value of a real-world, non-digital asset, such as a fiat currency, a commodity, or a financial instrument. Stablecoins are absent the volatility of other cryptocurrencies and, as such, are a useful medium of exchange. An example stablecoin includes, without limitation, USDC™.

In general, users hold digital assets on a chain and can manage digital assets using externally owned accounts (EOAs). An EOA is an account that is associated with a public key and a private key pair. A digital wallet can be described as a software application that enables users to access and transact digital assets on chains through one or more EOAs. A digital wallet executes off-chain and stores private keys of each of the one or more EOAs. An EOA can be used to initiate a transaction that is executed using a smart contract account (SCA). The SCA is maintained on-chain and executes transactions triggered by user operations (userOps).

Implementations of the present disclosure are described in further detail herein with reference to example peer-to-peer networks (also referred to herein as chain networks), each maintaining a respective chain. The example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, Base, and Tron, among several others.

Executing transactions in peer-to-peer networks requires the consumption of technical resources (e.g., processing, memory). In other words, computational effort is expended. In the context of Ethereum, gas refers to a unit of measure of the amount of computational effort required to execute specific operations. To pay for a transaction, a transaction fee, referred to as a gas fee in Ethereum, is determined as the amount of gas used to perform operations of the transaction, multiplied by a cost per unit gas. The transaction fee is paid regardless of whether a transaction succeeds or fails. In Ethereum, transaction fees (gas fees) are paid in Ethereum's native cryptocurrency, which is referred to as ether (ETH).

In using digital assets as a means of exchange, users may have digital assets on one chain that they would like to use on another chain. For example, a user can seek to execute a transaction on a destination chain, but pay transaction fees for the transaction on the destination chain using a digital asset that is maintained on a source chain. However, each chain network maintains a native cryptocurrency, which is used to facilitate transactions in that chain network. Users interact with multiple chain networks, each chain network having its own native cryptocurrency.

To highlight this, a non-limiting illustrative example can be considered, which includes Alice transferring a digital asset (e.g., a NFT) to Bob in a chain network. The transfer requires computational effort (in Ethereum, gas) to execute the transaction in the chain network, which requires a transaction fee (in Ethereum, gas fee that is paid in ETH). In this example, Alice has an amount of cryptocurrency (e.g., stablecoin) in a SCA in the chain network that Alice would like to use to pay the transaction fee. However, Alice's cryptocurrency on the source chain is non-native with respect to the chain network.

Such scenarios present multiple issues. For example, in a traditional approach, multiple transactions would need to be executed to facilitate the transaction on the chain network. With continued reference to the non-limiting example above, Alice would have to obtain a sufficient amount of native cryptocurrency to cover the transaction fees. This, however, can itself require multiple transactions and commensurate expenditure of technical resources, not to mention additional transaction fees. Further, and in some instances, Alice would have to initiate each of the multiple transactions from respective EOAs. This not only consumes resources on the device Alice uses (user-side computing devices), but also diminishes user experience (UX) (e.g., navigating between multiple EOAs and waiting for one transaction to complete before initiating a next transaction).

In view of the foregoing, implementations of the present disclosure are directed to permissionless cryptocurrency abstraction with decentralized liquidity for transactions using non-native cryptocurrency. Here, cryptocurrency abstraction refers to enabling users to use a non-native cryptocurrency to account for transaction fees in a native cryptocurrency. As described in further detail herein, implementations of the present disclosure provide a permissionless paymaster in the chain network that enables users to use the non-native cryptocurrency to account for transaction fees payable in the native cryptocurrency for transactions executed within the chain network. In accordance with implementations of the present disclosure, amounts of native cryptocurrency are provided within the chain network from a decentralized liquidity source. In some implementations, and as described in further detail herein, the decentralized liquidity source includes multiple liquidity providers (LPs)

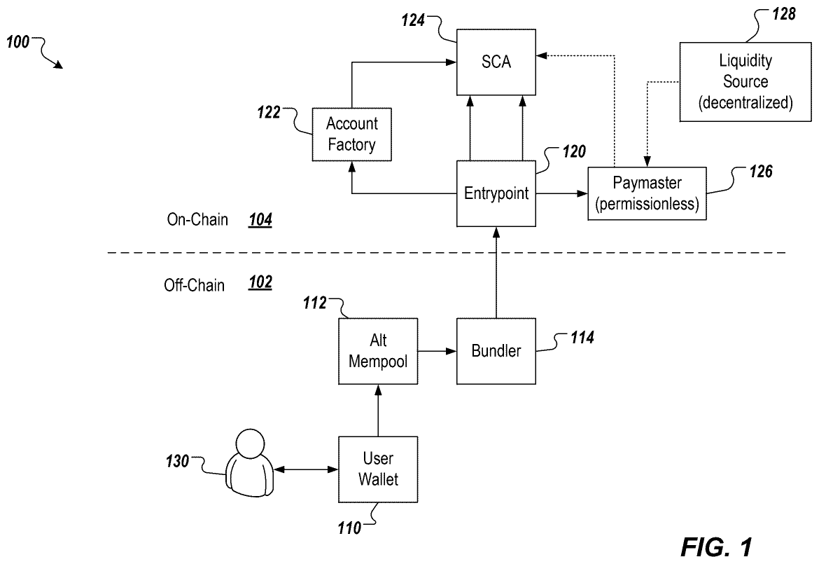

FIG. 1 depicts a conceptual architecture 100 in accordance with implementations of the present disclosure. In the example of FIG. 1, the architecture 100 includes an off-chain network 102 and an on-chain network 104. The off-chain network 102 represents components that are executed off-chain (e.g., one or more computing devices that are independent of a chain network) and the on-chain network 104 represents components that are executed on a chain network. In the example of FIG. 1, dashed arrows indicate transfers of cryptocurrency between components.

In the example of FIG. 1, the off-chain network 102 includes a user wallet 110, an alternative memory pool (alt mempool) 112, and a bundler 114. In some examples, the user wallet 110 is an off-chain program that stores private keys of a user 130, each private key corresponding to an account (e.g., SCA) of the user 130 on a chain maintained by the on-chain network 104. The bundler 114 listens to user operations added to the alt mempool 112 and packages user operations into bundles. Although a single bundler is depicted, it is contemplated that multiple bundlers can be provided. The bundler 114 sends bundles of user operations as regular transactions to nodes of the on-chain network 104.

In some examples, the alt mempool 112 serves as off-chain storage for user operations that are to be executed on the chain of the on-chain network 104. At a high-level, the alt mempool 112 can be described as a memory pool that holds pending user operations that have not been picked up for execution by the bundler 118. The alt mempool 112 can be described as an alternative to (is different from) so-called canonical memory pools that are used to hold user operations for respective nodes of the on-chain network 104. For example, alt mempools can include specific rules that are to be observed. An example rule of the alt mempool 112 can include, without limitation, that the alt mempool 112 prevents multiple SCAs from reading and writing to the same nonce. Another example rule of the alt mempool 112 can include, without limitation, a paymaster (discussed below) being included on a whitelist of paymasters. Further details of alternative memory pools are provided in Ethereum Request for Comment (ERC) 4337 (ERC-4337) (also referred to as Ethereum Improvement Proposal (EIP) 4337 (EIP-4337)), which is incorporated herein by reference in the entirety for all purposes.

Components executed in the on-chain network 104 can be provided as smart contracts. Smart contracts can be described as programs that are executed on-chain and are each provided as a collection of code (functions) and data (state) that resides at a specific address on the chain.

In the example of FIG. 1, the on-chain network 104 includes an entrypoint 120, an account factory 122, a SCA 124, a paymaster 126, and a liquidity source 128. In some examples, the entrypoint 120 receives a bundle (of user operations) from the bundler 118. In some examples, a user operation can include creating a user account (e.g., SCA) for a user within the on-chain network 104. This can be described as onboarding the user to the on-chain network 104. For example, if the user 130 does not have an account with the on-chain network, a user operation can be executed to trigger the account factory 122 to create the SCA 124 for the user 140. In some examples, a user operation can represent a transaction that a user is requesting be executed between accounts in the on-chain network 104. For each such user operation in the bundle, the entrypoint 120 performs validation before enabling execution of the transaction.

In accordance with implementations of the present disclosure, the paymaster 126 is a smart contract that is permissionless and facilitates payment of transaction fees in the on-chain network 104 on behalf of users. For example, and as described in further detail herein, the paymaster 126 can accept a non-native (from the perspective of the on-chain network 104) cryptocurrency (e.g., USDC™) and account for transaction fees in a native (from the perspective of the on-chain network 104) cryptocurrency (e.g., ETH) of the on-chain network 104. Implementations of the present disclosure will be described in further detail herein with reference to USDC™ as a non-native cryptocurrency and ETH as a native cryptocurrency from the perspective of the on-chain network 104. It is contemplated, however, that implementations of the present disclosure can be realized using an appropriate non-native cryptocurrency and/or any appropriate native cryptocurrency.

To account for transaction fees for transactions executed in the on-chain network 104, native cryptocurrency can be provided from the liquidity source 128 and can, for example, be used to compensate the bundler 118 and the paymaster 126 using the native cryptocurrency. In accordance with implementations of the present disclosure, and as described in further detail herein, the liquidity source 128 is considered decentralized in that the liquidity source 128 is not provisioned or controlled by any individual entity and any entities involved in the liquidity source 128 do not need to know or trust one another. Entities involved in the liquidity source 128 can be described as liquidity providers (LPs), as described in further detail herein.

In accordance with implementations of the present disclosure, and as introduced above, the paymaster 126 is deployed to the on-chain network 104 (e.g., a destination chain, on which a transaction for the user 130 is to be executed) to account for transaction fees on behalf of users (e.g., the user 130). As described in further detail herein, the paymaster 126 enables transaction fees to be accounted for in a native cryptocurrency using a non-native cryptocurrency held by the user 130. That is, the user 130 need not hold any native cryptocurrency (e.g., in the SCA 124) or convert their non-native cryptocurrency into native cryptocurrency.

As described in detail herein, the paymaster 126 is permissionless. This means that any SCA on the on-chain network (e.g., the SCA 124) can use the paymaster for any transaction without first requesting and receiving permission to do so. For example, the paymaster 126 enables the SCA 124 to account for user operations executed in the on-chain network 104 entirely in the non-native cryptocurrency (e.g., USDC™). The paymaster 126 does this by accepting payment from the SCA 124 in the non-native cryptocurrency and paying for the user operations in the native cryptocurrency (e.g., ETH). As also described in further detail herein, the paymaster 126 enables the user 130 to be onboarded to the on-chain network 104 (e.g., creating the SCA 124 for the user 140) only using the non-native cryptocurrency. In the context of ETH, this can be referred to as ETH-less onboarding.

In further detail, the paymaster 126 is funded with native cryptocurrency liquidity from the (decentralized) liquidity source 128. The paymaster 126 pays for user operations in the native cryptocurrency (e.g., ETH), while charging a fee in the non-native cryptocurrency (e.g., USDC™). This enables the user 130 to pay for their transaction entirely in the non-native cryptocurrency.

In some implementations, the paymaster 126 includes a deposit with the entrypoint 120. The deposit includes an amount of native cryptocurrency of the paymaster 126 held on the entrypoint 120 for payment of transactions. In some implementations, the paymaster 126 includes a stake with the entrypoint 120. The stake includes an amount of native cryptocurrency provided by the paymaster 126 and held on the entrypoint 120. In some implementations, the paymaster 126 includes a deposit with the entrypoint 120, the deposit including an amount of native cryptocurrency for payment of transactions Here, the paymaster 126 can use native cryptocurrency provided from the liquidity source 128 for payment of the deposit to the entrypoint 120.

In some implementations, the paymaster 126 is configured with a set of functions that can be called to facilitate execution of transactions. Example functions include a paymaster validation function (validatePaymasterUserOp) and a post operation function (postOp). Other example functions include a deposit function (deposit), a withdraw to function (withdrawTo), a get deposit function (getDeposit), an add stake function (addStake), an unlock stake function (unlockStake), and a withdraw stake function (withdrawStake), each of which is discussed in further detail in EIP-4337.

In some examples, the paymaster validation function is called by the entrypoint 120 to check whether the paymaster 126 will process the transaction (user operation (UserOp)). For example, the paymaster 126 can determine whether the user requesting the transaction has already approved the paymaster 126 to transfer cryptocurrency on the user's behalf. In some examples, if the provider of the paymaster 126 has control over the SCA implementation, a function can be provided in the SCA 124 that only the paymaster 126 can call during execution of validatePaymasterUserOp. This function would give the paymaster 126 an allowance in the non-native cryptocurrency (e.g., the paymaster 126 is approved to pull USDC™ from the SCA 124 up to an allowance amount). More specifically, this function calls “approve” on a non-native cryptocurrency contract, which is automatically allowed because the SCA 124 (owner of funds) is the one calling the function. In some examples, if the provider of the paymaster 126 does not have control over the SCA implementation, the SCA 124 can include generic logic to provide its own validateUserOp function, which would approve the paymaster 126 for non-native cryptocurrency using a user-provided off-chain signature (“permit”). In some examples, a special alt mempool would be needed for this, because of certain ERC-4337 restrictions.

In some implementations, the SCA 124, from which the non-native cryptocurrency is to be transferred to the paymaster 126, can include an automatic approval feature or can include an allowance feature. In some examples, the automatic approval feature enables the SCA 124 to automatically approve transfer of an amount of the non-native cryptocurrency as requested by the paymaster 126. In some examples, the allowance can be set to an unlimited allowance (MAX_INT) or can be set to a predefined amount. If the allowance is an unlimited allowance, the amount of non-native cryptocurrency requested from the paymaster 126 is not limited (e.g., only limited to the amount of non-native cryptocurrency available from the SCA 124). If the allowance is set to a predefined amount, the amount of non-native cryptocurrency requested from the paymaster 126 is limited by the predefined amount. For example, requests are approved until the predefined amount is expended or is insufficient. In some examples, users can check the balance of the predefined amount and can increase the predefined amount. However, an increase in the predefined amount expends computation power and, thus, incurs transaction fees.

In some examples, the paymaster 126 uses a stored foreign exchange rate (fxRate) to calculate a maximum transaction fee (TF_{MAX}) for the transaction (userOp) in the non-native cryptocurrency and executes a transfer from function (transferFrom) to transfer the amount of TF_{MAX} in the non-native cryptocurrency from the SCA 124 (of the user 140) to the paymaster 126. In some examples, the entrypoint 120 supplies a value maxCost to validatePaymasterUserOp to note the maximum amount of native cryptocurrency the transaction might need. In view of this, the paymaster 126 can take the corresponding value from the SCA 124. In executing the postOp function (at the end of the transaction), the entrypoint 120 supplies a value actualGasUsed to the function. Where this is less than the maxCost, the paymaster 126 can refund the difference back to the SCA 124, as described in detail herein. In some examples, the userOp specifies a callGasLimit and maxFeePerGas. This caps the amount of native cryptocurrency the call can use for execution (callGasLimit) as well as sets the maximum the user is willing to pay per unit of native cryptocurrency (max FeePerGas).

It can be noted that, prior to initiating the transaction, the user 130 has already enabled the paymaster 126 to transfer from the SCA 124. That is, for example, the SCA 124 stores an approval, which indicates that the paymaster 126 is approved to transfer from the SCA 124. The paymaster validation function succeeds, if the transfer of the non-native cryptocurrency is successful. Otherwise, the paymaster validation function fails and the transaction is not executed.

If the paymaster validation function succeeds, and one or more other validations are successful (e.g., the validate user operation function (validateOp( ) is successful), the entrypoint 120 calls an execute user operation function (executeOp( ) of the SCA 124 to execute the transaction within the on-chain network 104.

After the transaction is complete, the entrypoint 120 calls the post operation function (postOp) of the paymaster 126. In some examples, the entrypoint 120 informs the paymaster 126 (e.g., through the postOp call) of the actual transaction fee (TF_{ACT}) incurred for execution of the transaction. The paymaster 126 pays the actual transaction fee (TF_{ACT}). For example, the actual transaction fee (TF_{ACT}) is paid to the bundler 118 by the entrypoint 120 using the deposit of native cryptocurrency of the paymaster 126 that is stored on the entrypoint 120.

In some examples, the paymaster 126 deducts any fees and refunds any excess to the SCA 124 in the non-native cryptocurrency. For example, the paymaster 126 can determine a total cost (T_{COST}) to the user 140 using the following example relationship:

$${T}_{COST} = ( 1 + S ) * FXR * ( {NC}_{P RICE} * A ) + F F \qquad ( 1 )$$

where S is a spread, FXR is the foreign exchange rate (e.g., native cryptocurrency to non-native cryptocurrency), NC_{PRICE} is a current market price of computing power in the native crypto-currency (e.g., ETH/gas), A is additional computing power that is to be charged for, and FF is a flat fee (e.g., in the non-native cryptocurrency). The spread can be described as a percentage-based fee. Here, TF_{ACT}=NC_{PRICE}*A.

In some implementations, as part of execution of the post operation function, the paymaster 126 determines T_{COST} and a refund amount (T_{REF}) as a difference between TF_{MAX} and T_{COST}. The paymaster 126 transfers the refund amount to the SCA 124 in the non-native cryptocurrency.

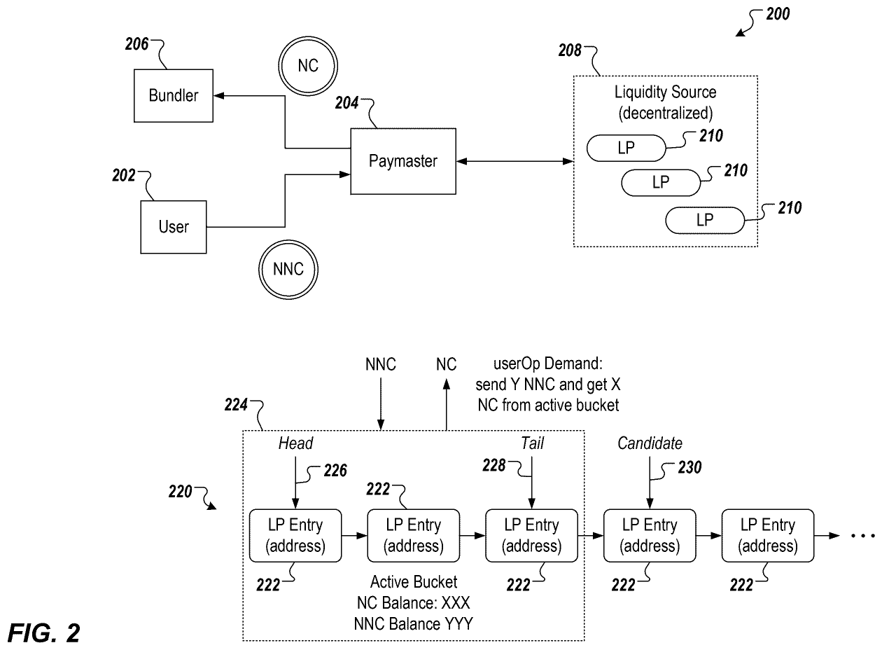

FIG. 2 depicts a high-level conceptual architecture 200 to illustrate implementations of the present disclosure. In the example of FIG. 2, the architecture 200 includes a user (e.g., the user 130 of FIG. 1), a paymaster 204 (e.g., the paymaster 126 of FIG. 1), a bundler 206 (e.g., the bundler 114 of FIG. 1), and a liquidity source 208 (e.g., the liquidity source 128 of FIG. 1). In the example of FIG. 2, the liquidity source 208 includes LPs 210. Although three LPs 210 are depicted in the example of FIG. 2, any appropriate number of LPs 210 can be provided (e.g., tens, hundreds, thousands). In some examples, the liquidity source 208 can be referred to as a pool (e.g., a pool of native cryptocurrency). As described herein, the paymaster 204 can receive non-native cryptocurrency (NNC) from the user 202 (e.g., from a SCA of the user 202) to pay for transactions in native cryptocurrency (NC). For example, the paymaster 206 can provide an amount of native cryptocurrency to the bundler 206 involved in a transaction (e.g., through the stake with the entrypoint 120 of FIG. 1).

As discussed herein, the liquidity source 208 provides a pool of native cryptocurrency that can be accessed by the paymaster 204 to account for transaction fees. In some examples, each LP 210 deposits an amount of native cryptocurrency with the paymaster 204, which can use the native cryptocurrency to account for transaction fees. In some examples, the LP 210 receives a number of funds distribution tokens (FDTs) for the amount of native cryptocurrency deposited based on an exchange rate between the FDT and the native cryptocurrency. FDTs are part of a funds distribution standard (FDS) that is described in further detail in ERC-2222. The LP 210 can later redeem its FDTs for an amount of native cryptocurrency and/or an amount of non-native cryptocurrency.

In accordance with implementations of the present disclosure, a spread control is used to incentivize LPs to participate in the liquidity source. In some examples, the spread (introduced in Equation 1, above) can be described as a (cryptocurrency) fee to the LPs to incentivize the LPs to participate in the liquidity source (e.g., provide a pool of native cryptocurrency). In some examples, the spread can be a percentage and/or a flat fec. In the context of the present disclosure, and as described in further detail below, each LP purchases the non-native cryptocurrency from the paymaster using the native cryptocurrency. In this manner, the paymaster has amounts of native cryptocurrency to account for transaction fees. In some implementations, a manual spread control can be used. In some implementations, a dynamic spread control can be used.

With regard to manual spread control, the paymaster can have a spread that is set as a constant (e.g., a percentage and/or a flat fee). In some implementations, an entity (e.g., a provider of the paymaster) can have access to a function in the paymaster, which can be executed to manually adjust the spread.

With regard to dynamic spread control, the dynamic spread control can be performed based on pool state (e.g., state of the liquidity source). For example, a pool state variable can include a liquidity level (an amount of native cryptocurrency that has been deposited by LPs) of the liquidity source, where a spread can be provided that increases when liquidity is low and decreases when liquidity is high. When liquidity is low, increasing the spread should lower the rate at which the native cryptocurrency (e.g., ETH) is spent and incentivize LPs with greater rewards. When liquidity is high, decreasing the spread should increase the rate at which the native cryptocurrency is spent and disincentivize new LPs. In some examples, another pool state variable to influence the spread can be the current market price of the native cryptocurrency. For example, the incentive of LPs to participate decreases when the market price of the native cryptocurrency increases. As such, in order to maintain incentives for LPs, the spread can increase, if the market price of the native cryptocurrency increases, as another dimension of dynamic spreading.

In further detail, to incentivize each LP in participating in the liquidity source, each LP will receive an amount of non-native cryptocurrency (e.g., USDC™) converted from their stake in a native cryptocurrency (e.g., ETH) as well as a (non-negative) spread. In accordance with implementations of the present disclosure, provisioning of the spread is in view of a set of conditions. Example conditions include incentive compatibility, non-negative, fee minimization, and feasibility. With regard to incentive compatibility, the spread should be large enough to provide LPs with incentive to contribute to the liquidity source, even during times where the pool size or the market price of the native cryptocurrency fluctuates significantly. With regard to non-negative, the spread should be a non-negative value. With regard to fee minimization, the spread should be kept as low as possible in order to reduce costs for users. With regard to feasibility, all parameters that are needed to calculate the spread at a time t must be known at the time t.

Intuitively, a spread mechanism that satisfies the incentive compatibility condition should enable LPs to earn more profit by depositing native cryptocurrency in the liquidity source rather than spending the native cryptocurrency elsewhere or holding. As such, sensible definitions regarding the profit gain by spending the native cryptocurrency elsewhere are provided and can be set as a benchmark for the incentive compatibility condition. To assist in further discussion below, the following notations can be considered:
tₖ: the timestamp, at which the k^{th} transaction occurs.
xₖ: the cost of the k^{th} transaction, denoted in the native cryptocurrency (e.g., ETH). This can be (TF_{ACT}+(NC_{PRICE}*A) of Equation 1, above.

$${r}_{i}^{k} :$$

the proportion of the i^{th} LP's asset compared to the whole liquidity pool at tₖ.
pₖ: the exchange rate between the native cryptocurrency and non-native cryptocurrency (e.g., ETH-to-USDC™) at time tₖ. This can be FXR of Equation 1, above.
sₖ: the spread value at time tₖ. This can be S of Equation 1, above.
fₖ: the constant fee at time tₖ. This can be FF of Equation 1, above.

In some examples, an amount of non-native cryptocurrency that a user pays the paymaster for executing a transaction can be defined as:

$${x}_{t} \cdot ( 1 + {s}_{t} ) \cdot {p}_{t} + {f}_{t} \qquad ( 2 )$$

Here, xₜ·pₜ is used to pay the bundler. As such, the paymaster can collect a fee of:

$$x \cdot ( 1 + s ) \cdot {p}_{t} + f - {x}_{t} \cdot {p}_{t} = x \cdot s \cdot {p}_{t} + {f}_{t} \qquad ( 3 )$$

With regard to the LPs, the FDS (introduced above with reference to ERC-2222) can be used to determine payments to the LPs. Using FDS, each LP is paid proportional to an asset ratio in the overall liquidity source. For example, the ratio between the native cryptocurrency stake of an i^{th} LP compared to the overall liquidity source can be provided as

$${r}_{i}^{t}$$

at the t. A profit of the i^{th} LP can be provided as:

$${r}_{i}^{t} [ x \cdot s \cdot {p}_{t} + {f}_{t} ] \qquad ( 4 )$$

which can be described as a reward to the i^{th} LP for participating in the liquidity source.

For purposes of illustration, instead of participating in the liquidity source, a LP can hold the native cryptocurrency it has. If participating in the liquidity source, a LP can be considered profitable if their share of native cryptocurrency in the paymaster has more value than if they had just held the native cryptocurrency. More particularly, if the i^{th} LP participates in the liquidity source during a time [tₐ, t_{b}], a profit earned by the i^{th} LP during the time [tₐ, t_{b}] can be determined as:

$${\sum }_{k = a}^{b} {r}_{i}^{k} [ {x}_{k} \cdot {s}_{k} \cdot {p}_{k} + {f}_{k} ] \qquad ( 5 )$$

However, if the i^{th} LP chose not to participate in the liquidity source during the time [tₐ, t_{b}], the value of the native cryptocurrency can be determined as:

$${p}_{b} \cdot [ {\sum }_{k = a}^{b} {r}_{i}^{k} \cdot {x}_{k} \cdot {p}_{k} ] \qquad ( 6 )$$

Accordingly, the spread [sₖ, fₖ] can be considered to be incentive compatible if:

$${\sum }_{k = a}^{b} {r}_{i}^{k} [ {x}_{k} \cdot {s}_{k} \cdot {p}_{k} + {f}_{k} ] \geq {p}_{b} \cdot [ {\sum }_{k = a}^{b} {r}_{i}^{k} \cdot {x}_{k} \cdot {p}_{k} ] \qquad ( 7 )$$

Through participation in the liquidity source, the native cryptocurrency of the LPs is gradually transferred to the non-native cryptocurrency through the paymaster. As such, the paymaster can be intuitively thought of as performing a volume-weighted trading strategy, and the volume weight of the price is decided by the size of the transaction cost xₖ along with the spread value sₖ.

In some implementations, a time-weighted average selling strategy can be considered. For example, and with non-limiting reference to ETH as a native cryptocurrency, it can be supposed that a LP holds 1 ETH and chooses to sell over a time interval of length 4. In this example, a time-weighted average selling includes selling 0.25 ETH during each time interval. An advantage of time-weighted average selling is that, if a large amount is sold at once, the market price may drop in view of the selling behavior, and profit can be lost. Instead of selling everything at once, a LP can sell small amounts of assets in each small time interval, selling the same amount of asset without generating price impact.

In view of this, the paymaster can receive a stable inflow of user operations that are to be executed. As such, the profit from time-weighted average selling can be determined as described in further detail. More particularly, and as introduced above, if the i^{th} LP participates in the liquidity source during a time [tₐ, t_{b}], the profit earned by the i^{th} LP during the time [tₐ, t_{b}] can be determined using Equation 5. However, another way to look at the paymaster is that the paymaster is performing volume-weighted average selling and the weight is the size of the transaction cost xₖ. Considering time-weighted average selling, and there being a stable inflow of user operations, a proxy for time-weighted average selling for the paymaster can be provided as:

$${\sum }_{k = a}^{b} \frac{( {\sum }_{k = a}^{b} {x}_{k} \cdot {r}_{i}^{k} )}{b - a + 1} \cdot {p}_{k} \qquad ( 8 )$$

Here, the spread [sₖ, fₖ] can be considered to be incentive compatible if:

$${\sum }_{k = a}^{b} {r}_{i}^{k} [ {x}_{k} \cdot {s}_{k} \cdot {p}_{k} + {f}_{k} ] \geq {\sum }_{k = a}^{b} \frac{( {\sum }_{k = a}^{b} {x}_{k} \cdot {r}_{i}^{k} )}{b - a + 1} \cdot {p}_{k} = [ \frac{1}{b - a + 1} \cdot {\sum }_{k = a}^{b} {p}_{k} ] \cdot {\sum }_{k = a}^{b} {x}_{k} \cdot {r}_{i}^{k} \qquad ( 9 )$$

Here, the term

$$\frac{1}{b - a + 1} \cdot {\sum }_{k = a}^{b} {P}_{k}$$

is average price within the time interval [tₐ, t_{b}] and the term

$${\sum }_{k = a}^{b} {x}_{k} \cdot {r}_{i}^{k}$$

is the total amount of the native cryptocurrency sold in the time interval [tₐ, t_{b}].

Whether time-weighted average selling or volume-weighted average selling is more profitable depends on the direction of price movement and price volatility of the native cryptocurrency. Using time-weighted average selling as a benchmark, the following advantages are provided as compared to volume-weighted trading:
1. Volume-weighted trading does not capture market volatility. For example, if price frequently moves up/down in a time period, then there may exist multiple timestamps that are better exit opportunities than cashing out at the last second.
2. Time-weighted average selling is a benchmark that captures the price volatility and smooths out the “cashing out” price as the average price in a time interval instead of the last second price.
3. Time-weighted average selling will sooner or later be enabled through multiple protocols.

In some implementations, each LP's proportion of native cryptocurrency can be stable compared to the overall size of the liquidity source across time. As such, the incentive between a LP and the paymaster will be perfectly aligned and the overall profit for the paymaster outperforming the benchmark should be ensured. In view of this, a balancing spread can be implemented that consistently outperforms time-weighted averaging selling. More particularly, NUM_{a,t} can denote the total number of trades between [tₐ, tₜ]⊂[tₐ, t_{b}] and can be provided as:

$${NUM}_{a , t} = t - a + 1 \qquad ( 10 )$$

An average price of the native cryptocurrency throughout the period [tₐ, tₜ], avg_{a,t}, can be provided as:

$${avg}_{a , t} ( p ) = \frac{{\sum }_{i = a}^{t} {p}_{i}}{{NUM}_{a , t}} \qquad ( 11 )$$

Here, the paymaster is profitable in the period [tₐ, tₜ] only if the following relationships hold:

$${\sum }_{k = a}^{t} ( 1 + {s}_{k} ) \cdot {p}_{k} \cdot {x}_{k} - {avg}_{a , t} ( p ) \cdot {\sum }_{k = a}^{t} {x}_{k} \geq 0 \qquad ( 12 )$$

$${s}_{k} \geq 0 \qquad ( 13 )$$

The balancing spread, sₜ, can be provided as:

$${s}_{t} = max \{ \frac{{avg}_{a , t} ( p ) \cdot {\sum }_{k = a}^{t} {x}_{k} - {\sum }_{k = a}^{t - 1} ( 1 + {s}_{k} ) \cdot {p}_{k} \cdot {x}_{k}}{{p}_{t} \cdot {x}_{t}} - 1 , 0 \} \qquad ( 13 )$$

Intuitively, the balancing spread finds the lowest spread at each timestamp that beats the time-weighted average selling benchmark.

In some implementations, the volume-weighted trading strategy can be incorporated into the balancing spread to provide the following relationship:

$${s}_{t} = max \{ \frac{max \{ {p}_{t} , {avg}_{u , t} ( p ) \} \cdot {\sum }_{i = u}^{t} {x}_{i} - {\sum }_{i = u}^{t - 1} ( 1 + {s}_{i} ) \cdot {p}_{i} \cdot {x}_{i}}{{p}_{t} \cdot {x}_{t}} - 1 , 0 \} \qquad ( 14 )$$

Under this design of balancing spread, all LPs will have the incentive to participate in the liquidity source and will likely choose to exhaust a budget of native cryptocurrency that they set. Meanwhile, the balancing spread also satisfies non-negativity conditions and feasibility conditions. It can be shown that there is not another spread satisfying all of the conditions, while having a consistently smaller spread value than the balancing spread. In this manner, there is a sense of guarantee that users will be protected from overly-high spread fees.

It can be noted, however, that FDS can result in numerical imprecision over time. Even using a maximum fixed precision (e.g., 77 decimal places for 256-bit numbers) for all calculations, the value to each LP can be significantly inaccurate (e.g., off by hundreds, if not thousands). This can occur for example, when new LPs join the liquidity source after other LPs had contributed amounts of native cryptocurrency and the transaction has been executed and paid for using non-native cryptocurrency from the liquidity source. Intuitively, after multiple iterations, all of the earlier participating LPs become less relevant and focus shifts to more recently participating LPs. Here, the exchange rate between the native cryptocurrency and the FDT should be rescaled (e.g., 1:1). However, such a naive way of rescaling will lose track of how much is to be returned to earlier participating LPs.

To illustrate this, the following non-limiting example can be considered, in which ETH is the native cryptocurrency and USDC™ is the non-native cryptocurrency. In the non-limiting example, Alice is the first LP ever in the system and has one FDT token for an amount of ETH (native cryptocurrency in this example) that Alice contributed to the liquidity source. The number of FDT tokens grows exponentially over time, and can reach upwards of, for example, 1×10⁵⁰ relatively quickly. Because the number of FDT tokens times ppsETH (e.g., the exchange rate between ETH and FDT) equals the total amount of ETH, the exchange rate can be thought of as being on a reciprocal level as the total number of FDT tokens. If there is 1 ETH in the liquidity source, then the eppsETH should be at the scale of 1× 10⁻⁵⁰. Meanwhile, ppsUSDC (e.g., the exchange rate between USDC™ and FDT) will gradually converge to a value very close to the ETH price. Going back to Alice's case, suppose that ppsUSDC is equal to 1500. If Alice redeems her asset, she should get back:

$$\# of FDT tokens Alice has * ppsETH = 1 * ( 1 \times {10}^{- 50} ) ETH and$$

$$\# of FDT token Alice has * ppsUSDC = 1500 USDC$$

The intuition here is that almost all of Alice's ETH has long been sold out in the system, and Alice basically is irrelevant as a LP. However, the number of FDT tokens that Alice holds is still used as a numeraire for accounting, so future LPs will get an exponential increasing value of FDT tokens. For example, suppose Ben and Cathy join at this moment. Ben deposits 1 ETH and Cathy deposits 2 ETH. Ben and Cathy will respectively receive:

$$1 ETH / ( 1 \times {10}^{- 50} ) ppsETH = 1 \times {10}^{50} FDT tokens$$

$$2 ETH / ( 1 \times {10}^{- 50} ) ppsETH = 2 \times {10}^{50} FDT tokens$$

As noted above, intuitively, we ppsETH should be rescaled to 1, which would result in Ben having 1 FDT token and Cathy having two FDT tokens. However, such a naive way of rescaling will result in losing how much is to be returned to Alice (the original LP).

In view of this, implementations of the present disclosure provide multiple strategies for resolving numerical imprecision. In general, strategies are designed to identify when a LP becomes irrelevant and execute rescaling without updating the number of FDT tokens held by each LP.

In one example strategy, implementations of the present disclosure provide for the introduction of a variable, LogState, which starts at 0, and multiple parameters are stored, which include current native cryptocurrency exchange rate (e.g., ppsETH), a current balance of native cryptocurrency in the liquidity source, an overall number of FDT tokens held by LPs, and a current non-native cryptocurrency exchange rate (e.g., ppsUSDC™). Further, a hash table is stored an has the LogState as the key. Initially, and using ETH and USDC™ as non-limiting examples, the hash table can be provided as:

| | | |
|---|---|---|
| LogState = 0 | LogState = 1 | LogState = 2 |

begin_ppsETH = 1
begin_ppsUSDC = 0

Everytime ppsETH drops below a threshold (e.g., 1×10⁻⁵⁰), a new ppsETH (new_ppsETH) is set equal to 10⁵⁰ times the previous ppsETH (old_ppsETH) and a new ppsUSDC (new_ppsUSDC) is set equal to 10⁻⁵⁰ times the previous ppsUSDC (old_ppsUSDC). Because the old_ppsUSDC will converge to a value very close to the ETH price, the new_ppsUSDC can be set equal to 10⁻⁵⁰ times the old_ppsUSDC (≃0) and a new number of FDT tokens can be calculated as 10⁻⁵⁰ times the previous number of FDT tokens. The LogState is incremented and the hash table can be updated to be provided as:

| | | |
|---|---|---|
| LogState = 0 | LogState = 1 | LogState = 2 |

| | |
|---|---|
| begin_ppsETH = 1 | begin_ppsETH = |
| begin_ppsUSDC = 0 | new_ppsETH |
| end_ppsETH = | begin_ppsUSDC = 0 |
| old_ppsETH, | |
| end_ppsUSDC = | |
| old_ppsUSDC | |

Each time a new LP contributes to the liquidity source, the following values are recorded: the number of FDT tokens that the LP receives, a correction value (e.g., denominated in USDC™), the ppsETH, the ppsUSDC, and the LogState at the time of the contribution. If an LP contributes at LogState i, then at LogState i+2, the LP's asset should already be irrelevant and need not be considered in future calculations.

By way of non-limiting example, a LP contributes to the liquidity source at a LogState equal to i, with a correction value of c. In this example, if the current LogState is equal to i, the following is returned to the LP:

$$ETH = \# of FDT tokens * current\_ ppsETH$$

(this is exactly the amount of this LP's ETH left in the liquidity source)

$$USDC {™}^{} = \# of FDT tokens * current\_ ppsUSDC - correction$$

(this is exactly the amount of this LP's USDC™ collected.)
   As another example, if LogState is equal to i+1, the following is returned to the LP:

$$ETH = \# of FDT tokens - {10}^{- 50} * current\_ ppsETH$$

(this is exactly the amount of this LP's ETH left in the liquidity source)

$${USDC}^{} ™ = \# of FDT tokens * [ end\_ ppsUSDC at Log State i ] - correction + ( \# of FDT tokens * {10}^{- 50} * current\_ ppsUSDC )$$

(the first line is the amount of USDC™ gained by the LP at state i, and the second line is the amount of USDC™ gained by the LP at state i+1)
   As another example, if LogState is greater than i+1, the following is returned to the LP:

$$ETH = \# of FDT tokens * {10}^{- 50} * end\_ ppsETH ( at Log State i + 1 )$$

(this is exactly the amount of this LP's ETH left in the liquidity source at the end of State i+1, but there might be a little ‘dust’ ETH left in the pool, but the LP is irrelevant now)

$$USDC ™ = \# of FDT tokens * [ end\_ ppsUSDC at Log State i ] - correction + ( \# of FDT tokens - {10}^{- 50} * end\_ ppsUSDC ( at Log State i + 1 ) )$$

(the first line is the amount of USDC™ gained by the LP at state i, the second line is the amount of USDC™ gained by the LP at state i+1, there might be some ‘dust’ ETH left in the liquidity source by this LP, but is considered irrelevant and the stops generating profit in USDC™) From the LogState i+2, the LP's asset basically becomes irrelevant, so the USDC™ accrued by their contribution to the liquidity source is approximately zero.

In another example strategy, implementations of the present disclosure provide buckets to group LPs into immutable groups. In some implementations, and referring again to FIG. 2, a linked list 220 is provided, which stores an entry 222 for each LP that is offering to contribute non-native cryptocurrency to the liquidity source 208. An active bucket 224 can be provided as a sliding window to identify a group of LPs that have contributed non-native cryptocurrency to the liquidity source 208 and actively being used to account for transactions. The active bucket 224 can be defined from a start point, using a head pointer 226, and an end point, using an end pointer 228. In some examples, a candidate pointer 230 points to a next LP in the linked list that is offering to contribute non-native cryptocurrency to the liquidity source 208. In some examples, when the native cryptocurrency cost of a user operation exceeds an amount remaining in the active bucket 224, the pointers 226, 228 are moved forward to create a new active bucket. The active bucket 224 would no longer be active and LPs therein can claim earnings.

In some implementations, a maximum limit on deposits native cryptocurrency can be set for the active bucket and FDS is executed for LPs in the active bucket. Given that the active bucket is immutable (i.e., no new LPs can join an active bucket), the numerical precision issues can be obviated.

Implementations of the present disclosure can include multiple strategies for mitigating numerical precision concerns of FDS. In one example strategy, it can be mandated that all LPs deposit an exact amount of native cryptocurrency to the liquidity source. In this manner, any non-native cryptocurrency that is earned is distributed evenly amongst all LPs. In another example strategy, a first-in, first-out (FIFO) queue can be used and can be provided as a linked list of LPs that is used to maintain a queue of deposits of native cryptocurrency, where each deposit must be a defined amount of native cryptocurrency (e.g., X NC). Here, a lock can be placed on the first Y deposits in the queue, preventing withdrawals. The deposit at the front of the FIFO queue gets exhausted completely before being removed from the FIFO queue. If a deposit does not have enough left to cover a full cost of a user operation, a next deposit in the FIFO queue and the remainder can be claimed later by the LP associated with the insufficient deposit. In some examples, each deposit need not be the defined amount of native cryptocurrency (e.g., can be more/less than X NC). In such examples, when a user operation reaches the paymaster, the paymaster removes the first deposit and pushes the remainder of the deposit to the back of the FIFO queue.

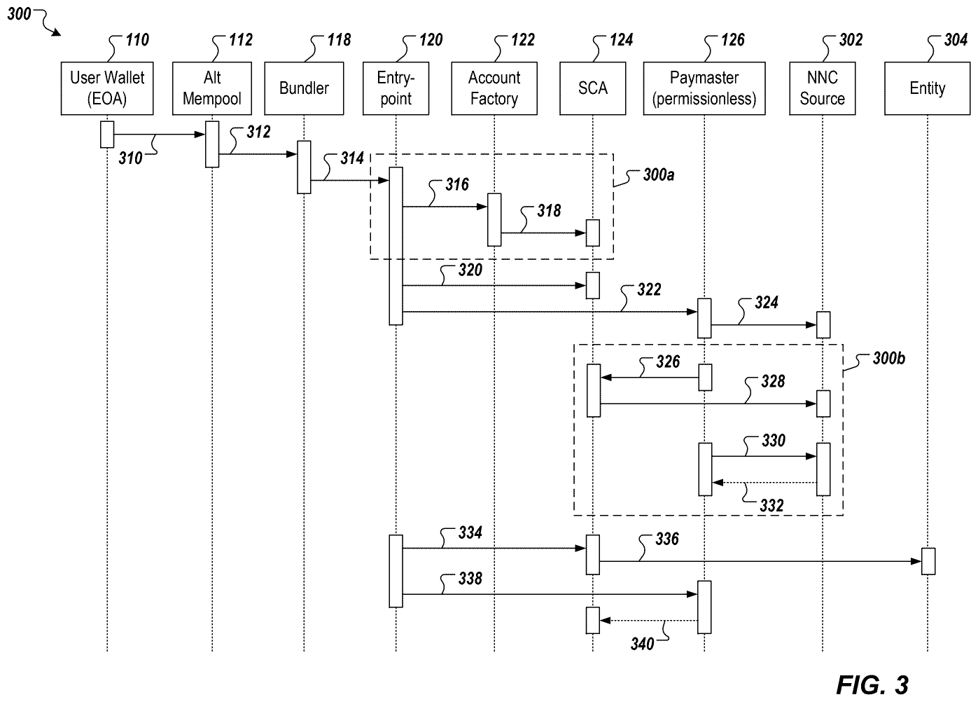

FIG. 3 depicts an example signal flow diagram 300 in accordance with implementations of the present disclosure. The example signal flow diagram 300 of FIG. 3 represents onboarding of a user to an on-chain network (e.g., creating a SCA for the user) without requiring the user to hold native cryptocurrency of the on-chain network (e.g., ETH-less onboarding introduced above). The example of FIG. 3 includes the user wallet 110, the alt mempool 112, the bundler 114, the entrypoint 120, the account factory 122, the SCA 124, the paymaster 126, a non-native cryptocurrency (NNC) source 302 (e.g., USDC™ contract), and an entity 304. In this example, a user (e.g., the user 130) requests execution of a transaction with the entity 304 (e.g., another SCA, a distributed application (dAPP)).

The user wallet 110 submits (310) a user operation (userOp) to the alt mempool 112. The bundler 114 retrieves (312) the user operation from the altmempool 112. The bundler 114 bundles the user operation with other user operations and sends (314) the bundle to the entrypoint 120. In some examples, the user operation includes an initialization code field (initCode) and a paymaster and data field (paymasterAndData). In some examples, if the user operation includes initiating creation of an SCA for the user in the chain network, the initialization code field includes an address of the account factory that is to create the SCA (e.g., the account factory 122). If the user operation does not include initiating creation of an SCA (e.g., a SCA already exists for the user), the initialization code field is set to a pred-determined value (e.g., 0). In some examples, the paymaster and data field includes the address of the paymaster 126 within the on-chain network 104.

In some examples, and as noted above, the user operation can include creation of the SCA 124. For example, and with reference to FIG. 1, the first time that the user 140 interacts with the on-chain network 104, the user does not have a SCA.

Consequently, the SCA 124 can be created for the user 140 by the account factory 122. This can be indicated by the initialization code field (initCode) of the user operation being set to a non-zero value (e.g., userOp.initCode≠0). Here, the value of the initialization code can be an address of the account factory 122 for deployment of a SCA on the chain (e.g., on the on-chain network 104). In this scenario, a sub-flow 300a is executed, in which the entrypoint 120 calls (316) a create account function (createAccount) of the account factory 122, which initializes (318) the SCA 124.

The entrypoint 120 validates (320) the user operation with the SCA 124 (e.g., calls validateOp ( ) and validates (322) the paymaster 126 (e.g., calls validatePaymasterUserOp ( ). In response to the validation call (e.g., during the paymaster validation), the paymaster 126 checks (324) an allowance given to the paymaster 126 to transfer from the NNC source 202. In some examples, the NNC source 302 is a source of non-native cryptocurrency (e.g., USDC™ contract) to determine whether there is sufficient allowance to transfer an amount of non-native cryptocurrency (e.g., TF_{MAX}) from the SCA 124 to the paymaster 126. In some examples, if the allowance is less than the amount requested (e.g., TF_{MAX}), a sub-flow 300b is executed, in which the paymaster 126 calls (326) an approve paymaster function (approvePaymaster ( ) of the SCA 124, and the SCA calls an approve function (approve ( ) of the NNC source 302 (e.g., USDC™ contract). In some examples, the call includes parameters specifying the paymaster 126 (e.g., address of the paymaster 126 in the on-chain network 104) and an allowance amount (e.g., unlimited allowance (MAX_INT)). Here, the sub-flow 300b can be called when the SCA 124 is newly created, per the sub-flow 300a, and is not yet funded with non-native cryptocurrency. Consequently, the paymaster 126 is able to pull non-native cryptocurrency from the NNC source 302 to enable using only the non-native cryptocurrency in on-boarding the SCA 124 (e.g., ETH-less onboarding). In some examples, instead of the NNC source 302, the non-native cryptocurrency can be provided from an onramp solution. For example, from an exchange that allows cost-free sends of non-native cryptocurrency, from an SCA of another user, or from an existing SCA of the user.

If the allowance is sufficient or the paymaster 126 has been approved, the paymaster 126 calls (330) a transfer from function of the NNC source 302, which transfers (332) the amount of non-native cryptocurrency from the NNC source 302 to the paymaster 126.

In some examples, the sub-process 300b need not be performed. For example, after creation of the SCA 124, the user can fund the SCA 124 with non-native cryptocurrency, which the paymaster 126 can pull from (instead of pulling from the NNC source 302), as described in detail herein.

If the validations are successful, the entrypoint 120 calls (334) an execute user operation function (executeOp ( ) of the SCA 124, which executes (336) the transaction within the entity 204. After the transaction is complete, the entrypoint 120 calls (338) the post operation function (postOp) of the paymaster 126. In some examples, the entrypoint 120 informs the paymaster 126 (e.g., through the postOp call) of the actual transaction fee (TF_{ACT}) incurred for execution of the transaction. The paymaster 126 pays the actual transaction fee (TF_{ACT}). For example, the actual transaction fee (TF_{ACT}) is paid to the bundler 114 by the entrypoint 120 using the deposit of native cryptocurrency of the paymaster 126 that is stored on the entrypoint 120. As described in further detail herein, the paymaster 126 refunds (340) any excess of the non-native cryptocurrency to the SCA 124 (e.g., T_{REF}).

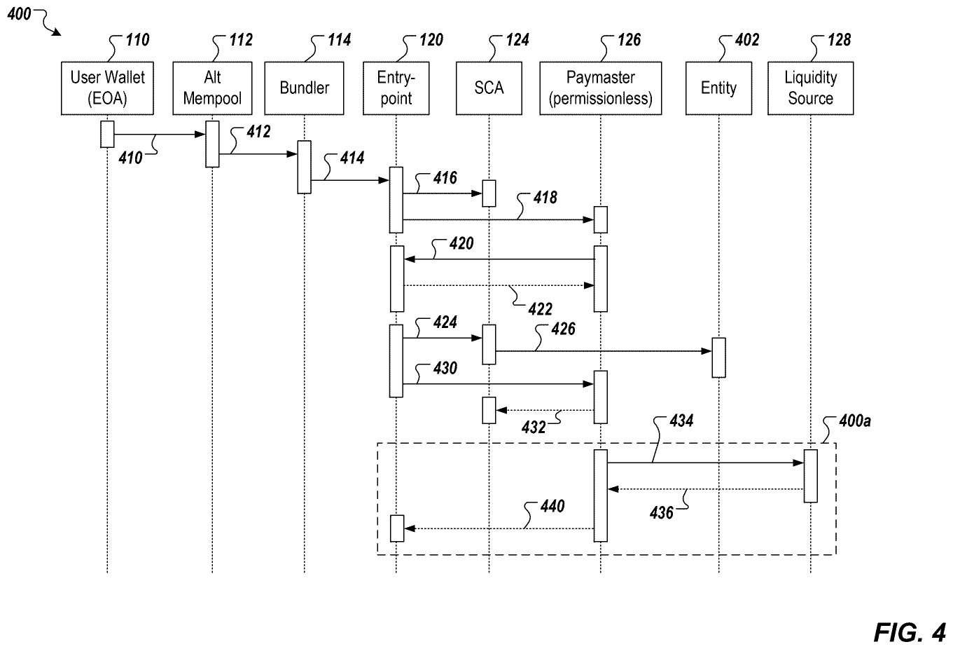

FIG. 4 is an example signal flow diagram 400 in accordance with implementations of the present disclosure. The example signal flow diagram 400 of FIG. 4 represents execution of a transaction and use of decentralized liquidity to provide native cryptocurrency. The example of FIG. 3 includes the user wallet 110, the altmempool 112, the bundler 114, the entrypoint 120, the SCA 124 (already on-boarded), the paymaster 126, an entity 402, and the liquidity source 128. In this example, a user (e.g., the user 130) requests execution of a transaction with the entity 402 (e.g., another SCA, a distributed application (dAPP)).

The user wallet 110 submits (410) a user operation (userOp) to the alt mempool 112. The bundler 114 retrieves (412) the user operation from the altmempool 112. The bundler 114 bundles the user operation with other user operations and sends (414) the bundle to the entrypoint 120. The entrypoint 120 validates (416) the user operation with the SCA 124 (e.g., calls validateOp ( ) and validates (418) the paymaster 126 (e.g., calls validatePaymasterUserOp ( ). In response to the validation call (e.g., during the paymaster validation), the paymaster 126 determines the maximum amount of the transaction fee (TF_{MAX}) and calls (420) a transfer from function (transferFrom ( ) of the SCA 124, which transfers an amount of non-native cryptocurrency (e.g., TF_{MAX}) to the paymaster 126.

If the validations are successful, the entrypoint 120 calls (424) an execute user operation function (executeOp ( ) of the SCA 124, which executes (426) the transaction with the entity 402. After the transaction is complete, the entrypoint 120 calls (430) the post operation function (postOp) of the paymaster 126. In some examples, the entrypoint 120 informs the paymaster 126 (e.g., through the postOp call) of the actual transaction fee (TF_{ACT}) incurred for execution of the transaction. The paymaster 126 pays the actual transaction fee (TF_{ACT}). For example, the actual transaction fee (TF_{ACT}) is paid to the bundler 114 by the entrypoint 120 using the deposit of native cryptocurrency of the paymaster 126 that is stored on the entrypoint 120. As described in further detail herein, the paymaster 126 refunds (430) any excess of the non-native cryptocurrency to the SCA 124 (e.g., T_{REF}).

In some implementations, a sub-flow 400a is periodically executed to refresh an amount of native cryptocurrency available to the paymaster 126. For example, a balance of the deposit of native cryptocurrency on the entrypoint 120 that is available to the paymaster 126 can be periodically checked (e.g., a scheduled task). If the balance is below a threshold balance, the sub-flow 400a can be executed.

In the example of FIG. 4, the paymaster 126 can withdraw an amount of native cryptocurrency from the liquidity source 128 by requesting (434) and receiving (436) the amount of native cryptocurrency from the liquidity source 128. One or more LPs, which had deposited the native cryptocurrency receive amounts of non-native cryptocurrency (e.g., according to a FDS strategy implemented). The paymaster 126 can deposit the amount of native cryptocurrency with the entrypoint 120 as a stake for subsequent transactions.

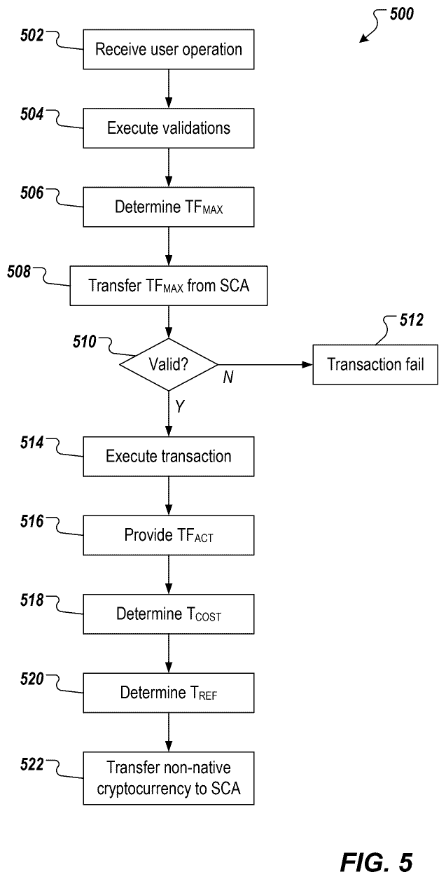

FIG. 5 depicts a flowchart of an example process 500 that can be executed in accordance with implementations of the present disclosure. For convenience, the process 500 will be described as being performed by a system of one or more computers located in one or more locations. For example, components of the architecture 100 of FIG. 1, appropriately programmed, can perform example process 500. Although the flowchart depicts the various stages of the process 500 occurring in a particular order, certain stages may in some implementations be performed in parallel or in a different order than what is depicted in the example process 500 of FIG. 5.

A user operation is received (502). For example, and as described in detail herein with reference to FIG. 1, the entrypoint 120 receives a user operation (userOp) from the bundler 114. In some examples, the user operation is one of multiple user operations in a bundle that the bundler 114 provides to the entrypoint 120. In some examples, the user operation is representative of a request to execute a transaction within the on-chain network 104 (e.g., transfer a digital asset from the SCA 124 to another SCA). Validations are executed (504). For example, and as described in detail herein, the entrypoint 120 calls a validate operation function (validateOp ( ) of the SCA 124 to validate the user operation and calls a validate paymaster function (validatePaymasterUserOp ( ) of the paymaster 126 to validate the paymaster as accounting for transaction fees due for execution of the user operation.

TF_{MAX} is determined (506) and TF_{MAX} is transferred from the SCA (508). For example, and as described in detail herein, in response to the paymaster validation call, the paymaster 126 determines the maximum amount of the transaction fee (TF_{MAX}) and calls a transfer from function (transferFrom ( ) of the SCA 124, which transfers an amount of non-native cryptocurrency (e.g., TF_{MAX}) to the paymaster 126.

It is determined whether the validations are successful (510). For example, and as described in detail herein, the entrypoint 120 receives responses from the SCA 124 and the paymaster 126, each response indicating whether the respective validation was successful. If the validations are not successful, the transaction fails (512). If the validations are successful, the transaction is executed (514). For example, and as described in detail herein, the entrypoint 120 calls an execute user operation function (executeOp ( ) of the SCA 124, which executes the user operation (e.g., to transfer a digital asset to another entity, such as a SCA). TF_{ACT} is provided (516). For example, and as described in detail herein, after the transaction is complete, the entrypoint 120 calls the post operation function (postOp) of the paymaster 126 and informs the paymaster 126 (e.g., through the postOp call) of the actual transaction fee (TF_{ACT}) incurred for execution of the transaction. The paymaster 126 pays the actual transaction fee (TF_{ACT}). For example, the actual transaction fee (TF_{ACT}) is paid to the bundler 114 by the entrypoint 120 using a deposit of native cryptocurrency of the paymaster 126 that is stored on the entrypoint 120.

T_{COST} is determined (518) and T_{REF} is determined (520). For example, and as described in detail herein, the total cost (T_{COST}) of the transaction is determined in the non-native cryptocurrency using Equation 1, above, and T_{REF} is determined as a difference between TF_{MAX} and T_{COST}. Non-native cryptocurrency is transferred to the SCA (522). For example, and as described in detail herein, the paymaster 126 refunds any excess of the non-native cryptocurrency to the SCA 124.

Implementations of the present disclosure provide multiple technical improvements. For example, the paymaster of the present disclosure enable user to execute transactions and account for transaction fees in a non-native cryptocurrency, encompassing even an initial onboarding stage. The paymaster of the present disclosure enables provide users with a seamless, unrestricted transaction experience on a chain network without the prerequisite of holding any cryptocurrency that is native to the chain network. As such, implementations of the present disclosure overcome limitations of traditional approaches, which are typically permissioned, imposing access restrictions, require off-chain user interactions, and/or lack the ability to onboard users to a chain network without the users already holding the native cryptocurrency (at least for their initial transaction on the chain network). Implementations of the present disclosure further enable the paymaster to access amounts of native cryptocurrency from the (decentralized) liquidity source. In this manner, the paymaster need not execute swaps of non-native cryptocurrency for native cryptocurrency with a distributed exchange, for example.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for execution of transactions within a chain network, comprising:
providing, within the chain network, a liquidity source comprising a set of liquidity providers that provide a pool of native cryptocurrency;
receiving, by a paymaster executed in the chain network, an amount of native cryptocurrency from the pool of native cryptocurrency;
receiving, by the paymaster, an amount of non-native cryptocurrency from a user to account for a transaction fee for execution of a transaction within the chain network; and
after execution of the transaction:
accounting for the transaction fee using at least a portion of the amount of native cryptocurrency,
determining, by the paymaster, a total cost of the transaction in the non-native cryptocurrency at least partially based on a spread, and
transferring, by the paymaster, respective amounts of non-native cryptocurrency to one or more liquidity providers in the set of liquidity providers based on the spread.

2. The computer-implemented method of claim 1, wherein the amounts of non-native cryptocurrency transferred to the one or more liquidity providers are determined using a funds distribution standard (FDS) that is based on ratios of native cryptocurrency deposited by respective liquidity providers relative to an overall amount of native cryptocurrency in the liquidity source.

3. The computer-implemented method of claim 1, further comprising storing a hash table that records a set of parameters used to calculate a returned amount of native cryptocurrency and a returned amount of non-native cryptocurrency for participation of each liquidity provider in the liquidity source.

4. The computer-implemented method of claim 3, wherein the set of parameters comprises, for each log state of a plurality of log states, a set of exchange rates for the native cryptocurrency and a set of exchange rates for the non-native cryptocurrency relative to a funds distribution token (FDT).

5. The computer-implemented method of claim 1, further comprising storing a linked list of liquidity providers in the chain network, the linked list of liquidity providers being used to determine the amounts of non-native cryptocurrency to one or more liquidity providers in the set of liquidity providers.

6. The computer-implemented method of claim 5, further comprising using a set of pointers to define an active window of the linked list, the active window defining the one or more liquidity providers for transfer of the amounts of non-native cryptocurrency.

7. The computer-implemented method of claim 5, wherein the linked list is provided as a first-in, first-out (FIFO) queue to determine the one or more liquidity providers for transfer of the amounts of non-native cryptocurrency.

8. The computer-implemented method of claim 1, wherein a value of the spread changes over time.

9. The computer-implemented method of claim 1, wherein the paymaster is provided and deployed to the chain network by an enterprise that provides the non-native cryptocurrency.

10. A non-transitory computer-readable storage medium coupled to one or more processors and having instructions stored thereon which, when executed by the one or more processors, cause the one or more processors to perform operations for execution of transactions within a chain network, the operations comprising:
providing, within the chain network, a liquidity source comprising a set of liquidity providers that provide a pool of native cryptocurrency;
receiving, by a paymaster executed in the chain network, an amount of native cryptocurrency from the pool of native cryptocurrency;
receiving, by the paymaster, an amount of non-native cryptocurrency from a user to account for a transaction fee for execution of a transaction within the chain network; and
after execution of the transaction:
accounting for the transaction fee using at least a portion of the amount of native cryptocurrency,
determining, by the paymaster, a total cost of the transaction in the non-native cryptocurrency at least partially based on a spread, and
transferring, by the paymaster, respective amounts of non-native cryptocurrency to one or more liquidity providers in the set of liquidity providers based on the spread.

11. The non-transitory computer-readable storage medium of claim 10, wherein the amounts of non-native cryptocurrency transferred to the one or more liquidity providers are determined using a funds distribution standard (FDS) that is based on ratios of native cryptocurrency deposited by respective liquidity providers relative to an overall amount of native cryptocurrency in the liquidity source.

12. The non-transitory computer-readable storage medium of claim 10, wherein operations further comprise storing a hash table that records a set of parameters used to calculate a returned amount of native cryptocurrency and a returned amount of non-native cryptocurrency for participation of each liquidity provider in the liquidity source.

13. The non-transitory computer-readable storage medium of claim 12, wherein the set of parameters comprises, for each log state of a plurality of log states, a set of exchange rates for the native cryptocurrency and a set of exchange rates for the non-native cryptocurrency relative to a funds distribution token (FDT).

14. The non-transitory computer-readable storage medium of claim 10, wherein operations further comprise storing a linked list of liquidity providers in the chain network, the linked list of liquidity providers being used to determine the amounts of non-native cryptocurrency to one or more liquidity providers in the set of liquidity providers.

15. The non-transitory computer-readable storage medium of claim 14, wherein operations further comprise using a set of pointers to define an active window of the linked list, the active window defining the one or more liquidity providers for transfer of the amounts of non-native cryptocurrency.

16. The non-transitory computer-readable storage medium of claim 14, wherein the linked list is provided as a first-in, first-out (FIFO) queue to determine the one or more liquidity providers for transfer of the amounts of non-native cryptocurrency.

17. A system, comprising:
a computing device; and
a computer-readable storage device coupled to the computing device and having instructions stored thereon which, when executed by the computing device, cause the computing device to perform operations for execution of transactions within a chain network, the operations comprising:
providing, within the chain network, a liquidity source comprising a set of liquidity providers that provide a pool of native cryptocurrency;
receiving, by a paymaster executed in the chain network, an amount of native cryptocurrency from the pool of native cryptocurrency;
receiving, by the paymaster, an amount of non-native cryptocurrency from a user to account for a transaction fee for execution of a transaction within the chain network; and
after execution of the transaction:
accounting for the transaction fee using at least a portion of the amount of native cryptocurrency,
determining, by the paymaster, a total cost of the transaction in the non-native cryptocurrency at least partially based on a spread, and
transferring, by the paymaster, respective amounts of non-native cryptocurrency to one or more liquidity providers in the set of liquidity providers based on the spread.

18. The system of claim 17, wherein the amounts of non-native cryptocurrency transferred to the one or more liquidity providers are determined using a funds distribution standard (FDS) that is based on ratios of native cryptocurrency deposited by respective liquidity providers relative to an overall amount of native cryptocurrency in the liquidity source.

19. The system of claim 17, wherein operations further comprise storing a hash table that records a set of parameters used to calculate a returned amount of native cryptocurrency and a returned amount of non-native cryptocurrency for participation of each liquidity provider in the liquidity source.

20. The system of claim 17, wherein operations further comprise storing a linked list of liquidity providers in the chain network, the linked list of liquidity providers being used to determine the amounts of non-native cryptocurrency to one or more liquidity providers in the set of liquidity providers.
